(19) United States
(12) Patent Application Publication
(10) Pub. No.: US 2025/0105327 A1
(43) Pub. Date: Mar. 27, 2025

(54) FLOW BATTERY CHARGING INITIATION METHOD, CONTROLLER FOR FLOW BATTERY SYSTEM AND FLOW BATTERY SYSTEM

(71) Applicant: VFLOW TECH PTE. LTD., Singapore (SG)

(72) Inventors: Arjun BHATTARAI, Singapore (SG); Avishek KUMAR, Singapore (SG); Alok SAHU, Singapore (SG)

(73) Assignee: VFLOW TECH PTE. LTD., Singapore (SG)

(21) Appl. No.: 18/683,133

(22) PCT Filed: Aug. 29, 2022
(86) PCT No.: PCT/SG2022/050617

§ 371 Date: Feb. 12, 2024

(30) Foreign Application Priority Data
Aug. 27, 2021 (SG) 10202109401P

(51) Int. Cl. H01M 8/18; H01M 8/04225; H01M 8/04302; H01M 8/04746; H01M 8/04858

(52) U.S. Cl. CPC H01M 8/188; H01M 8/04225; H01M 8/04302; H01M 8/04753; H01M 8/04865; H01M 8/04895

(57) ABSTRACT

Charging initiation methods for flow batteries, controllers for flow batteries and flow battery systems are disclosed. A charging initiation method for a flow battery which allows charging of the flow battery from an AC power supply with a power converter having a minimum operational DC voltage is described. Details of the flow battery construction are provided. The charging initiation method so described includes a pre-charging initiation condition that varies depending on a DC voltage threshold or a current threshold.

### CROSS REFERENCE TO RELATED APPLICATIONS

This application is a § 371 application of International Application No. PCT/SG2022/050617, filed Aug. 29, 2022, which claims the benefit of SG patent application Ser. No. 10/202,109401P, filed Aug. 27, 2021, which are incorporated by reference as if fully set forth.

### TECHNICAL FIELD

The present disclosure relates to flow batteries and in particular to charging initiation methods for flow batteries.

### BACKGROUND

The flow battery market has been rapidly growing for industrial energy storage applications. Flow battery systems and in particular vanadium redox flow battery (VRFB) systems have various advantages, such as high safety, long lifetime, low maintenance and scalability. The capacity of flow battery systems can be flexibly scaled up as it is related to the size of tanks containing positive electrolytes and negative electrolytes, which are fluidically connected with the cell stack of a flow battery system.

During the Installation and commissioning of a VRFB system, typically positive and negative tanks of the battery are filled with the electrolyte with vanadium concentration at the same oxidation states (V^{+3.5}). This gives 0 volts between the DC terminals of the cell stack. To first start the system, it requires several hours of pre-charge to split the vanadium ions to V^{+3.x} (in the negative tank) and V^{+4.x} (in the positive tank) to reach the state of charge of above 0%. At an installation site, typically this process is very time consuming and requires external DC power supply to charge the electrolyte before the AC system can be activated to charge the VRFB system from an AC power source such as an AC power grid.

Typically, power converters which convert AC power to DC power require a minimum DC voltage at the cell stack for the power converter to be turned on to charge the flow battery. If the cell stack terminals do not provide the minimum DC voltage required by the power converter, the power converter will not turn on to charge the flow battery. Conventionally, the electrolytes are charged in the flow battery system by connecting an external DC supply across the stack terminals or at DC bus in multi-stack system to increase the voltage at the cell stack, while the pumps exchanging electrolytes in the cell stack. This process consumes a very long time (e.g. a 10 kW-100 kWh flow battery system will typically need at least 50 kWh energy to reach a sufficient state of charge of the electrolytes as the electrolytes are gradually charged at low C rate.

PCT application publication WO2019016748 describes a method to pre-charge flow batteries from zero state of charge, where a charge initiator circuit along with external power supply and a battery charger (an inverter-charger) participate. In their method, an external power supply unit provides a voltage above the threshold voltage of the inverter to turn the inverter ON. Once the inverter is turned ON, it provides with a DC voltage greater than the external power supply unit, which initiates a circuit whose function is to switch a series pass element so as to initiate the charging process. One drawback of this method is that in case of charging or discharging (while delivering load) a power MOSFET, a Power BJT or a series pass element is always in the conducting path. This element is prone to being faulty after a period of time, and it reduces the reliability of the whole system. Another drawback of this arrangement is that it affects the efficiency of power transfer.

### SUMMARY

The present invention provides charging initiation methods for flow batteries, controllers for flow battery systems and flow battery systems which reduce the time required for pre-charging flow batteries. The pre-charging may take place during installing and commissioning of the flow battery systems or during servicing of flow batteries.

According a first aspect of the present invention, a charging initiation method for a flow battery is provided. The charging initiation method allows charging of the flow battery from an AC power supply with a power converter having a minimum operational DC voltage. The flow battery comprises a positive electrolyte tank containing a positive electrolyte, a negative electrolyte tank containing a negative electrolyte, a cell stack comprising a positive porous electrode and a negative porous electrode, a positive electrolyte pump which when activated pumps the positive electrolyte from the positive electrolyte tank through the positive porous electrode, and a negative electrolyte pump which when activated pumps the negative electrolyte from the negative electrolyte tank through the negative porous electrode. The charging initiation method comprises: connecting a DC power supply to the positive porous electrode and the negative porous electrode to charge the cell stack, while the positive electrolyte pump and the negative electrolyte pump are deactivated; in response to a pre-charging condition: disconnecting the DC power supply from the positive porous electrode and the negative porous electrode; connecting the power converter coupled to the AC power supply to the positive porous electrode and the negative porous electrode to charge the cell stack from the AC power supply; and activating the positive electrolyte pump and the negative electrolyte pump.

The pre-charging condition may be that a stack voltage of the cell stack exceeds a voltage threshold which is greater than or equal to the minimum operational DC voltage of the power converter. Additionally or alternatively, the pre-charging condition may be a charging current from the DC power supply falling below a current threshold.

The charging initiation method has the advantage of reducing the time required for pre-charging the flow battery (or for preparing the flow battery for normal charging), by charging the cell stack while the pumps are deactivated. This means that only the electrolytes in the cell stack are charged from the DC power supply. Thus, the DC voltage at the cell stack may be raised in a short period of time to at least meet the minimum DC voltage required by the power converter for the power converter to turn on and charge the electrolytes. Conventional methods use external DC power to pre-charge the flow batteries while the pumps are exchanging the electrolytes between electrolyte tanks and cell stack. Compared to the conventional methods, the method described herein simplifies the process and improves the efficiency of pre-charging the flow batteries.

In an embodiment of the charging initiation method, prior to connecting the DC power supply to the positive porous electrode and the negative porous electrode to charge the cell stack, the charging initiation method further comprises activating the positive electrolyte pump and the negative electrolyte pump to refresh positive electrolyte located in the positive porous electrode and negative electrolyte located in the negative porous electrode and then deactivating the positive electrolyte pump and the negative electrolyte pump. Refreshing the electrolytes located in the electrodes brings uniformity of the electrolytes throughout the cell stack.

In an embodiment of the charging initiation method, the DC power supply comprises an AC-DC power supply unit or a bidirectional/uni-directional DC-DC converter.

In an embodiment of the charging initiation method, the AC power supply is an AC power grid.

In an embodiment of the charging initiation method, the power converter is an AC/DC bi-directional inverter.

In an embodiment of the charging initiation method, the flow battery is a redox flow battery. Further, the positive electrolyte and the negative electrolyte may comprise vanadium.

In an embodiment of the charging initiation method, the pre-charging condition comprises a voltage between the positive porous electrode and the negative porous electrode exceeding a voltage threshold which is greater than or equal to the minimum operational DC voltage of the power converter.

In an embodiment of the charging initiation method, the voltage threshold is greater than the minimum operational DC voltage by 1 volt, preferably by 5 volts and more preferably by 10 volts.

In an embodiment of the charging initiation method, the voltage threshold is in the range 20 volts to 1500 volts.

In an embodiment of the charging initiation method, the pre-charging condition comprises a charging current from the DC power supply falling below a current threshold.

In an embodiment of the charging initiation method, the current threshold is in the range 1 A to 1000 A.

According to a second aspect of the present invention, a controller for a flow battery system is provided. The controller is configured to control the flow battery system to carry out the charging initiation method according to any of the above embodiments. The controller may be used to control any applicable flow battery to improve the efficiency of pre-charging of the flow battery.

According to a third aspect of the present invention, a flow battery system is provided. The flow battery system comprises a flow battery comprising a positive electrolyte tank containing a positive electrolyte, a negative electrolyte tank containing a negative electrolyte, a cell stack comprising a positive porous electrode and a negative porous electrode, a positive electrolyte pump which when activated pumps the positive electrolyte from the positive electrode tank through the positive porous electrode, a negative electrolyte pump which when activated pumps the negative electrolyte from the negative electrode tank through the negative porous electrode; a DC power supply which is electrically couplable to the cell stack; a power converter having a minimum operational voltage and which is electrically couplable to the cell stack; and a controller configured to initiate charging of the flow battery using a method comprising: connecting the DC power supply to the positive porous electrode and the negative porous electrode to charge the cell stack, while the positive electrolyte pump and the negative electrolyte pump are deactivated; in response to a pre-charging condition: disconnecting the DC power supply from the positive porous electrode and the negative porous electrode; connecting the power converter coupled to an AC power supply to the positive porous electrode and the negative porous electrode to charge the cell stack from the AC power supply; and activating the positive electrolyte pump and the negative electrolyte pump.

Conventional flow battery systems normally use external DC power to pre-charge the flow batteries to meet the minimum DC voltage required by the power converter so that the power converter can be turned on and charge the flow batteries using AC power, or use a Power BJT, a Power MOSFET or series pass element in its conductive path to provide the required minimum DC voltage to the power converter, while the pumps are exchanging the electrolytes between tanks and cell stack. The flow battery system, by charging the cell stack of the battery while the pumps are deactivated, reduces the time required for pre-charging the flow battery or starting the system, and avoid the need of using any Power BJT, Power MOSFET or series pass element in conductive path while charging or discharging and reduce complex hardware requirement, which minimizes the chance of failure of the charging initiation function of the flow battery system. Therefore, the flow battery system described herein has the advantage of higher efficiency, better simplicity and more sustainability and reliability, compared to the conventional flow battery systems.

In an embodiment of the flow battery system, prior to connecting the DC power supply to the positive porous electrode and the negative porous electrode to charge the cell stack, the method further comprises activating the positive electrolyte pump and the negative electrolyte pump to refresh positive electrolyte located in the positive porous electrode and negative electrolyte located in the negative porous electrode and then deactivating the positive electrolyte pump and the negative electrolyte pump. Refreshing the electrolytes located in the electrodes brings uniformity of the electrolytes throughout the cell stack.

In an embodiment of the flow battery system, the DC power supply comprises an AC-DC power supply unit or a bidirectional/uni-directional DC-DC converter.

In an embodiment of the flow battery system, the AC power supply is an AC power grid.

In an embodiment of the flow battery system, the power converter is an AC/DC bi-directional inverter.

In an embodiment of the flow battery system, the flow battery is a redox flow battery. Further, the positive electrolyte and the negative electrolyte may comprise vanadium.

In an embodiment of the flow battery system, the pre-charging condition comprises a voltage between the positive porous electrode and the negative porous electrode exceeding a voltage threshold which is greater than or equal to the minimum operational DC voltage of the power converter.

In an embodiment of the flow battery system, the voltage threshold is greater than the minimum operational DC voltage by 1 volt, preferably 5 volts and more preferably 10 volts.

In an embodiment of the flow battery system, the voltage threshold is in the range 20 volts to 1500 volts.

In an embodiment of the flow battery system, the pre-charging condition comprises a charging current from the DC power supply falling below a current threshold.

In an embodiment of the flow battery system, the current threshold is in the range 1 A to 1000 A.

Further embodiments are set out in the following statements:

1. A flow battery system comprising:
a positive electrolyte tank containing a positive electrolyte;
a negative electrolyte tank containing a negative electrolyte;
an electrode stack comprising a positive porous electrode and a negative porous electrode separated by a membrane, the positive porous electrode and the negative porous electrode being coupled to respective stack DC terminals;
a positive electrolyte pump configured to pump positive electrolyte from the positive electrolyte tank though the positive electrode;
a negative electrolyte pump configured to pump negative electrolyte from the negative electrolyte tank though the negative electrode;
an AC/DC bi-directional inverter having inverter AC terminals couplable to an AC grid, and inverter DC terminals couplable to the stack DC terminals;
a DC power supply having power supply DC terminals couplable to the stack DC terminals; and
   a charging initiation controller configured to execute a charging sequence comprising:
      while the positive electrolyte pump and the negative electrolyte pump are deactivated, connecting the power supply DC terminals to the stack DC terminals to charge the electrode stack;
         in response to the voltage between the stack DC terminals exceeding a threshold,
         disconnecting the power supply DC terminals from the stack DC terminals;
         connecting the inverter AC terminals to the AC grid and connecting the inverter DC terminals to the stack DC terminals; and
         activating the positive electrolyte pump and the negative electrolyte pump.
            2. A flow battery system according to statement 1, wherein the charging sequence further comprises activating the positive electrolyte pump and the negative electrolyte pump to refresh the positive electrolyte and the negative electrolyte in the electrode stack, and disactivating the positive electrolyte pump and the negative electrolyte pump prior to connecting the power supply DC terminals to the stack DC terminals.
            3. A flow battery system according to statement 1 or statement 2, wherein the DC power supply is an AC/DC power supply having power supply AC terminals couplable to the AC grid.
            4. A flow battery system according to statement 3, wherein the charging sequence further comprises connecting the power supply AC terminals to the AC grid while the positive electrolyte pump and the negative electrolyte pump are deactivated, and disconnecting the power supply AC terminals from the AC grid in response to the voltage between the stack DC terminals exceeding the threshold.
            5. A flow battery system according to any preceding statement configured as a redox flow battery system.
            6. A flow battery system according to any preceding statement wherein the positive electrolyte and the negative electrolyte comprise vanadium.
            7. A charging initiation method for a flow battery, the method comprising: while a positive electrolyte pump and a negative electrolyte pump of the flow battery are deactivated, connecting a DC power supply to an electrode stack of the flow battery to charge the electrode stack; in response to a voltage between stack DC terminals of the electrode stack exceeding a threshold, disconnecting the DC power supply from the electrode stack; connecting inverter AC terminals of an AC/DC bidirectional inverter to an AC grid and connecting inverter DC terminals of the AC/DC bidirectional inverter to the electrode stack; and activating the positive electrolyte pump and the negative electrolyte pump.
            8. A charging initiation method according to statement 7, further comprising activating the positive electrolyte pump and the negative electrolyte pump to refresh a positive electrolyte and a negative electrolyte in the electrode stack, and disactivating the positive electrolyte pump and the negative electrolyte pump prior to connecting the DC power supply to the electrode stack.
            9. A charging initiation method according to statement 7 or statement 8, wherein the DC power supply is an AC/DC power supply having power supply AC terminals couplable to the AC grid.
            10. A charging initiation method according to statement 9, further comprising connecting the power supply AC terminals to the AC grid while the positive electrolyte pump and the negative electrolyte pump are deactivated, and disconnecting the power supply AC terminals from the AC grid in response to the voltage between the stack DC terminals exceeding the threshold.

### BRIEF DESCRIPTION OF THE DRAWINGS

In the following, embodiments of the present invention including the figures will be described as non-limiting examples with reference to the accompanying drawings in which:

FIG. 1 depicts a circuit of a flow battery system according to an embodiment of the present invention;

FIG. 2 depicts a flowchart of a charging initiation method for a flow battery according to an embodiment of the present invention;

FIG. 3 depicts a flowchart showing additional steps prior to the Step 210 depicted in FIG. 2;

FIG. 4 depicts a flowchart showing two sub-steps of the Step 220 depicted in FIG. 2;

FIG. 5 depicts a circuit of a flow battery system according to an embodiment of the present invention; and

FIG. 6 depicts a pump control circuit according to an embodiment of the present invention.

### DETAILED DESCRIPTION

The present disclosure provides charging initiation methods for one or more flow batteries, and flow battery systems comprising controllers that controls the initiation of charging of the flow batteries using the charging initiation methods, even in a grid-tied mode when the voltage at cell stacks of the flow batteries is 0V.

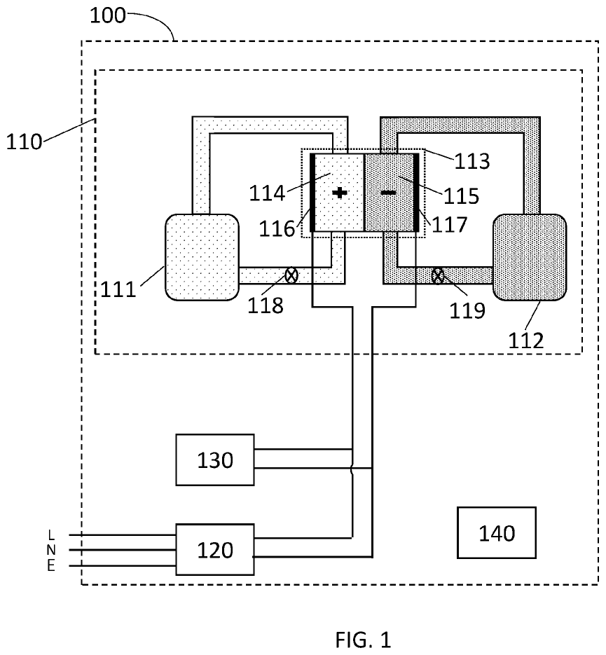

FIG. 1 depicts a circuit of a flow battery system according to an embodiment of the present invention. The flow battery system 100 comprises a flow battery 110, a power converter 120, a DC power supply 130 and a controller 140.

The flow battery 110 comprises a positive electrolyte tank 111, a negative electrolyte tank 112, a cell stack 113, a positive electrolyte pump 118 and a negative electrolyte pump 119. The cell stack 113 comprises a positive porous electrode 114 and a negative porous electrode 115. The positive porous electrode 114 and the negative porous electrode 115 are separated by an ion exchange membrane. The positive porous electrode 114 is coupled to a positive electrode current collector 116 and the negative porous electrode 115 is coupled to a negative electrode current collector 117. The cell stack 113 is coupled to DC lines (or DC bus in multi-stack system) for outputting power from the flow battery 110 to loads, or for receiving power from external power source to charge the cell stack 113 of the flow battery 110. When the cell stack 113 is charged, external power flows to the cell stack 113 so that the electrolytes in the cell stack 113 receive and store the energy from the external power. The positive electrolyte tank 111 contains a positive electrolyte. The positive electrolyte pump 118 is configured to drive the positive electrolyte from the positive electrolyte tank 111 to flow through the positive porous electrode 114, when activated.

The negative electrolyte tank 112 contains a negative electrolyte. The negative electrolyte pump 119 is configured to drive the negative electrolyte from the negative electrolyte tank 112 to flow through the negative porous electrode 115, when activated. During the course of charging the cell stack 113, if the pumps 118, 119 drive the electrolytes to flow through the positive porous electrode 114 and the negative porous electrode 115, the electrolytes passing through the cell stack 113 will be charged by receiving and storing the energy.

The power converter 120 is couplable to the positive porous electrode 114 and the negative porous electrode 115 of the cell stack 113 and charge the cell stack 113 with external power source. The power converter 120 requires a minimum DC voltage at the cell stack 113 for the power converter 120 to be turned on and charge the cell stack 113. For example, if a bi-directional inverter (SPMC 481) is used as the power converter, SPMC 481 requires a minimum DC voltage of 38 Volt for it to be turned on.

The power converter 120 in FIG. 1 is an AC/DC bi-directional inverter, comprising AC terminals couplable to AC power source and DC terminals couplable to the cell stack 113 of the flow battery 110. Specifically, DC terminals of the AC/DC bi-directional inverter are couplable to the positive porous electrode 114 and the negative porous electrode 115, for charging the cell stack 113 of the flow battery 110 with the AC power source or for outputting power from the cell stack 113 of the flow battery 110. The power converter 120 is configured to charge one cell stack at a time, or charge more than one cell stack at the same time wherein the cell stacks belong to one flow battery or different flow batteries. The connection between the power converter 120 and the flow battery 110 is detachable or non-detachable.

The DC power supply 130 is couplable to the positive porous electrode 114 and the negative porous electrode 115 of the cell stack 113 of the flow battery 110 and charge the cell stack 113 of the flow battery 110. The DC power supply 130 is a battery that is able to provide DC power to charge the cell stack 113 of the flow battery 110, or the DC power supply 130 comprises an AC-DC power supply unit comprising AC terminals couplable to AC power source and DC terminals couplable to the cell stack 113 of the flow battery 110, the DC terminals of the AC-DC power supply unit are couplable to the positive porous electrode 114 and the negative porous electrode 115 for charging the cell stack 113 of the flow battery 110, or the DC power supply 130 comprises a bidirectional/uni-directional DC-DC converter where input of the bidirectional/uni-directional DC-DC converter can be a battery (e.g. lead-acid battery, lithium-ion battery or any other energy storage entity) and the output of the bidirectional/uni-directional DC-DC converter is connected to the cell stack 113 of the flow battery 110. The DC power supply 130 is configured to charge one cell stack at a time, or more than one cell stack at the same time wherein the cell stacks belong to one flow battery or different flow batteries. The connection between the DC power supply 130 and the flow battery 110 is detachable or non-detachable.

An AC power source can be any source that is able to provide AC power as needed for the charging, such as the AC grid, a power generator (e.g. diesel generator) or a solar photovoltaic system, etc.

The controller 140 comprises a processing unit, such as CPU, MCU, DSP, FPGA, etc. 15 The controller 140 is configured to control the power converter 120, the DC power supply 130, the positive electrolyte pump 118, the negative electrolyte pump 119 and/or any switch used in the circuit of the flow battery system to connect any parts of the circuit. The voltage at the cell stack 113 of the flow battery 110 is detected by the controller 140, the DC power supply 130, the power converter 120, or any other device as applicable. The DC voltage at the cell stack 113 refers to the DC voltage between the positive porous electrode 114 and the negative porous electrode 115. The controller 140 is also configured to measure the charging current from the DC power supply when it is connected to the cell stack 113. For example, one or more sensors may be integrated in the DC line to detect the voltage at the cell stack 113 and amount of current flown. The controller 140 is configured to initiate charging of the flow battery using any one of the methods which will be discussed in detail below.

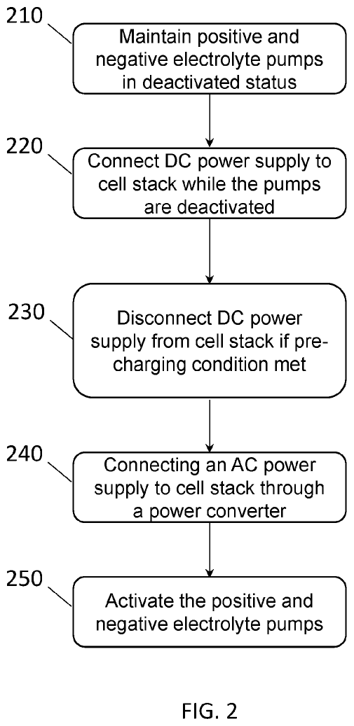

FIG. 2 depicts a flowchart of a method for initiating charging of a flow battery according to an embodiment of the present invention, which comprises the steps of (by referencing to the reference numerals in FIG. 1):
Step 210: Maintaining the positive electrolyte pump 118 and the negative electrolyte pump 119 of the flow battery 110 in deactivated status.
Step 220: Connecting a DC power supply 130 (which receives power from external AC power or DC power, subject to the type of DC power supply 130 as discussed above) to the positive porous electrode 114 and the negative porous electrode 115 to charge the cell stack 113, while the positive electrolyte pump 118 and the negative electrolyte pump 119 of the flow battery 110 are deactivated.
Step 230: In response to a pre-charging condition at the cell stack 113, disconnecting the DC power supply 130 from the positive porous electrode 114 and the negative porous electrode 115.
Step 250: Connecting an AC power supply to the positive porous electrode 114 and the negative porous electrode 115 through a power converter 120 to charge the cell stack 113.
Step 250: Activating the positive electrolyte pump 118 of the flow battery 110 to drive positive electrolyte contained in the positive electrolyte tank 111 to flow through the positive porous electrode 114 of the cell stack 113 and the negative electrolyte pump 119 of the flow battery 110 to drive negative electrolyte contained in the positive electrolyte tank 112 to flow through the negative porous electrode 115 of the cell stack 113.

In Step 210, there are two scenarios: 1) if either of the positive electrolyte pump 118 and the negative electrolyte pump 119 are activated, turn off the activated pump or pumps and then maintain both pumps in a deactivated state; 2) if both the pumps are already deactivated, then maintain both pumps in a deactivated state. When the pumps 118, 119 are deactivated, the positive electrolyte located in the positive porous electrode 114 and the negative electrolyte located in the negative porous electrode 115 of the cell stack 113 are not refreshed. Further, this step may be treated as part of Step 220.

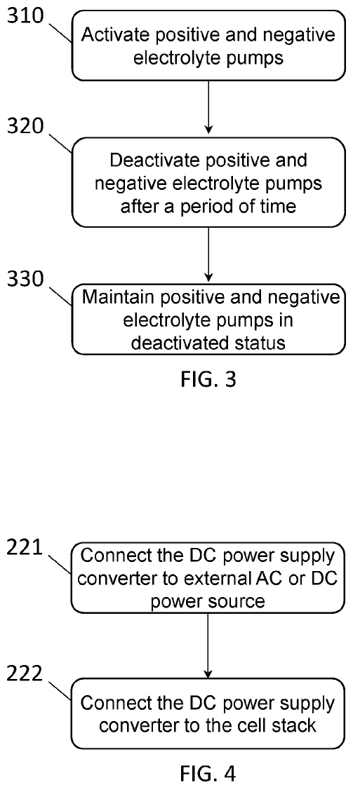

FIG. 3 depicts additional steps prior to Step 210 according to an embodiment of the present invention. In Step 310, the positive electrolyte pump 118 and the negative electrolyte pump 119 are activated. In Step 320, after both pumps 118, 119 have been activated for a period of time, deactivate both pumps 118, 119. In Step 330, maintain both pumps 118, 119 in deactivated status. By activating the positive electrolyte pump 118 for a period of time, the positive electrolyte is driven to exchange between the positive electrolyte tank 111 and the positive porous electrode 114 of the cell stack 113, so that the positive electrolyte located in the positive porous electrode 114 is refreshed before charging. Similarly, by activating the negative electrolyte pump 119 for a period of time, the negative electrolyte is driven to exchange between the negative electrolyte tank 112 and the negative porous electrode 115 of the cell stack 113, so that the negative electrolyte located in the negative porous electrode 115 is refreshed before charging.

For Step 220, where a DC power supply converter is used as the DC power supply 130 to convert an AC power to DC power or a DC power to DC power to charge the cell stack 113 of the flow battery 110, FIG. 4 depicts two sub-steps of Step 220 depicted in FIG. 2. Step 220 is divided into two consecutive sub-steps 221 and 222. In sub-step 221, the DC power supply converter is connected to an external AC power source or an external DC power source; thereafter in sub-step 222, the DC power supply converter is connected to the positive porous electrode 114 and the negative porous electrode 115 of the cell stack 113 of the flow battery 110. During the course of the charging, the voltage at the cell stack 113 and/or the charging current from the DC power supply is monitored.

In Step 230, the pre-charging condition may relate to a stack voltage being greater than a voltage threshold and/or a charging current from the DC power supply falling below a current threshold. When the pre-charging condition is met, charging of the cell stack 113 using the DC power supply 130 is stopped, by disconnecting the DC power supply 130 from the positive porous electrode 114 and the negative porous electrode 115.

The pre-charging condition for determining whether to stop charging the cell stack 113 using the DC power supply 130 is based on charging the electrolyte available inside the stack such that once the DC supply is disconnected, the cell stack 133 can sustain a buffer time before the power converter is activated and the cell stack is charged form the AC power supply.

The pre-charging condition may comprise a stack voltage being greater than a voltage threshold. Preferably, the voltage threshold is higher than the minimum DC voltage required by the power converter, e.g. threshold is greater than the minimum operational DC voltage by 1 volt, preferably by 5 volts and more preferably by 10 volts. For example, if a Selectronic SPMC 481 bi-directional inverter which has a minimum operational DC voltage of 38 volts is used as the power converter 120, the threshold may be set as 38 volts or higher, preferably 48 volts or higher. The pre-charging condition may additionally or alternatively comprise the charging current from the DC power supply 130 falling below a current threshold. The example application and auxiliary condition, the stack is pre-charged using the DC power supply, until the current drops to a range between 35 and 40 A hence ensuring the stack voltage stays above minimum operational voltage of the power converter until the power converter starts to charge the stack, while also supplying power to the auxiliary system.

It should be noted that the current threshold until which the stack is charged from the DC power supply will vary dependent on the auxiliary loading. For different systems and configurations this number will change. Generally, the voltage at the cell stack at which the DC power supply will be cut off is in the range 20V to 1500V and the charging current below which the DC power supply is cut off is in the range 1 A and 1000 A.

After charging of the cell stack 113 using the DC power supply 130 is stopped, the power converter 120 is connected to the positive porous electrode 114 and the negative porous electrode 115 of cell stack 113 for charging the cell stack 113 using an AC power source, as in Step 240. In other words, AC power supply is connected to the positive porous electrode 114 and the negative porous electrode 115 through the power converter 120.

In Step 250, after the power converter 120 is turned on and begins charging the cell stack 113, both the positive electrolyte pump 118 and negative electrolyte pump 119 are activated. The positive electrolyte pump 118 is activated to drive the positive electrolyte contained in the positive electrolyte 111 to flow through the positive porous electrode 114 of the cell stack 113. The negative electrolyte pump 119 is activated to drive the negative electrolyte contained in the negative electrolyte tank 112 to flow through the negative porous electrode 115 of the cell stack 113. Continue charging the cell stack 113 by the power converter 120 while the positive electrolyte pump 118 and the negative electrolyte pump 119 are activated allows charging the electrolytes in the whole flow battery system, including those initially located in the positive electrolyte tank 111 and negative electrolyte tank 112, hence the charging of the flow battery 110 is initiated.

The power converter 120 may continue charging the flow battery 110 until the charging task is completed. The charging task may be considered completed when the state of charge of the flow battery reaches a desired percentage, or when a predetermined time expires, or when the external AC power source stops providing power.

The charging initiation methods may be performed manually by a person, or automatically by a controller. The charging initiation methods allow initiating the charging of flow batteries in grid-tied mode, even when the flow batteries is not charged or the DC voltage at a cell stack is 0 Volt.

The charging initiation methods described herein may be applied in different conditions, e.g. for the first time of installing flow batteries, for servicing of flow batteries, or any other similar conditions.

In view of the methods described above, and referring back to FIG. 1 and FIG. 2, according to an embodiment of the present invention, the controller 140 is configured to initiate charging of the flow battery 110 using a method comprising: connecting the DC power supply 130 to the positive porous electrode 114 and the negative porous electrode 115 to charge the cell stack 113, while the positive electrolyte pump 118 and the negative electrolyte pump 119 are deactivated; and in response to a pre-charging condition: disconnecting the DC power supply 130 from the positive porous electrode 114 and the negative porous electrode 115; connecting an AC power supply to the positive porous electrode 114 and the negative porous electrode 115 through an power converter 120 to charge the cell stack 113; and activating the positive electrolyte pump 118 to drive the positive electrolyte contained in the positive electrolyte tank 111 to flow through the positive porous electrode 114 and the negative electrolyte pump 119 to drive the negative electrolyte contained in the negative electrolyte tank 112 to flow through the negative porous electrode 115.

The charging initiation methods provided in the present invention may be used to initiate charging of different types of flow batteries (such as redox flow battery) comprising various chemistries. For example, the electrolytes may contain any of vanadium ions, lithium ions, manganese ions, titanium ions, chromium ions, zinc ions, iron ions and lead ions, etc. Similarly, the flow battery systems provided in the present invention may comprise different types of flow batteries.

Among various types of flow batteries, it is flaunted that vanadium redox flow battery (VRFB) exhibits advantages in terms of fire safety, stable capacity and long life compared to other technologies like Li-ion and lead acid batteries. The electrolyte used in VRFB is nonflammable and does not degrade over the time, ensuring long life. According to an embodiment of the present invention, the charging of a new VRFB using a charging initiation method is described below.

Typically, during the installation and commissioning of the VRFB, positive electrolyte tank and negative electrolyte tank of the battery are filled with the electrolytes with vanadium concentration at the same oxidation states (V+3·5) across the cell stack, which provide 0 Volt of voltage at DC terminals of electrodes of the cell stack. In the circumstances, to first start the system, it usually requires several hours of pre-charging to split the vanadium ions to V^{+3.x} (on negative side) and V^{+4.x} (on positive side) to reach the state of charge of above 0%.

As described in the background section, the conventional way of charging the electrolytes by connecting an external DC supply across the stack terminals or at DC bus in multi-stack system, in grid-tied mode, while the pumps exchange electrolytes between the tanks and the cell stack, is very time-consuming before the AC system can be activated.

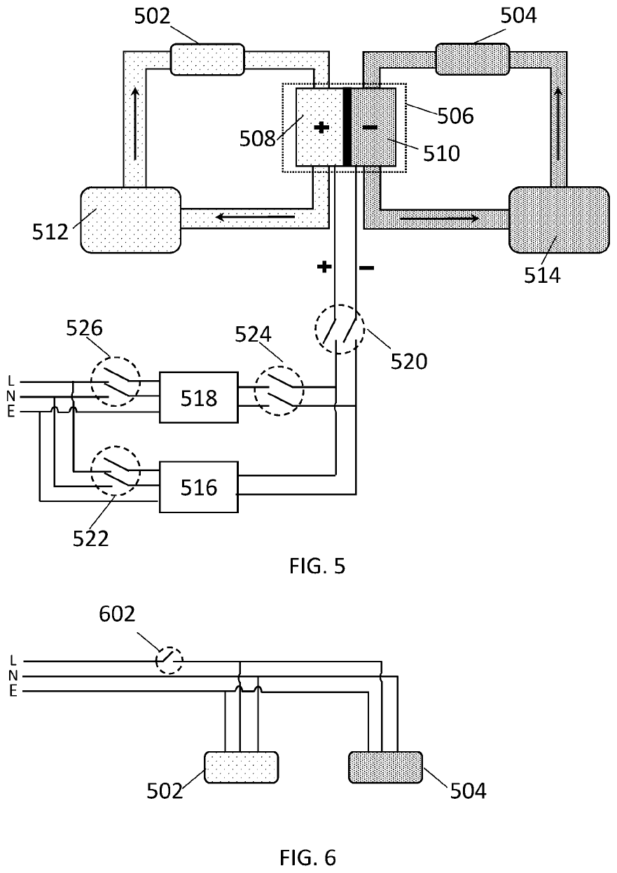

Using a charging initiation method according to an embodiment of the present invention, the cell stack is charged to a DC voltage such that a power converter can turn on (after pre-charging condition) and charge the flow battery from an AC grid or other AC source. After power flows to the cell stack from the AC source via the power converter, the pumps of the flow battery will be activated to avoid any overvoltage condition. Thereafter, charging will continue as needed without any interruption. Specifically, reference is made to FIG. 5 and FIG. 6 in which show steps of charging the a VRFB as follows:
Step 1: Activate the positive electrolyte pump 502 and negative electrolyte pump 504 to refresh the electrolytes located in the positive porous electrode 508 and negative porous electrode 510 of the cell stack 506 by switching on the switch 602, then deactivate both pumps by switching off the switch 602.
Step 2: Turn on the switch 520 (e.g. Double pole DC miniature circuit breaker (MCB)).
Step 3: Turn on the switch 526 (e.g. Double pole MCB) to start an AC-DC power supply unit 518.
Step 4: Turn on the switch 524 (e.g. Double pole MCB) to electrically connect the DC terminals of the cell stack 506 with DC terminals of the AC-DC power supply unit 518 to charge the cell stack 506.
Step 5: Once sufficient stack voltage is reached (e.g. 48 Volt, if the stack nominal voltage is 48 Volt), and I or once the charging current from the AC-DC power supply unit 518 falls below the threshold current (e.g. 35 A to 40 A) the switch 524 and the switch 526 are turned off.
Step 6: Turn on the switch 522 (e.g. Double pole MCB) to charge the cell stack 506 using an AC/DC bi-directional inverter 516 with the power from AC main or AC grid.
Step 7: Once the power flows to cell stack 506 from AC main or AC grid through the AC/DC bi-directional inverter 516, the positive electrolyte pump 502 is activated to drive the positive electrolyte in the positive electrolyte tank 512 to flow through the positive porous electrode 508, and the negative electrolyte pump 504 is activated to drive the negative electrolyte in the negative electrolyte tank 514 to flow through the negative porous electrode 510, whereupon the charging of the flow battery is initiated.
Step 8: Continue charging the flow battery using the AC/DC bi-directional inverter 516 until state of charge of the flow battery reaches the minimum requirement for battery to operate normally.

Instead of charging the complete electrolytes (including those stored in the tanks) to raise the state of charge of the VRFB, only the electrolytes contained in the cell stack 506 are charged during the pre-charging stage, when the pumps are deactivated. The time taken for charging the electrolytes only in the cell stack depends on the number of cells and the surface area of the cells in the cell stack. The operating voltage and current of the DC power supply will be dependent on the number of stacks to be pre-charged, which depends on the configuration and size of the flow battery system. The size reflects the power and energy storage capacity of the flow battery system. Therefore, the voltage range of the DC power supply may be between 20V and 1500V, while the DC power supply current range capability may lie between 1 A and 1000 A. The DC power supply can be a small AC/DC power supply (with 48V or higher output depending on the stack voltage requirement) which is widely available. This method simplifies the pre-charge process and reduces the requirement (e.g. size) of expensive bidirectional DC power supply and logistic issues to initiate the charging of flow batteries. The charging time and commissioning time can therefore be reduced significantly.

The methods and systems proposed in the present invention avoid the long pre-charge time by charging the cell stack without exchanging electrolytes between tanks and the cell stack. This allows to charge the electrolytes only available inside the cell stack which produces sufficient DC voltage in a very minimal time even with a small DC source, so that the power converter can sense the available DC voltage at the cell stack and turn on to be able to charge the flow battery directly from the external AC source. This avoids requirement of expensive high power DC charger and minimizes long waiting time (e.g. several hours) during system commissioning. Since the newly invented methods and systems do not engage a Power BJT or a Power MOSFET or series pass element in its conductive path while charging or discharging, there is a minimal chance of failure of the charging initiation function of the flow battery system.

It is envisaged that the flow battery, the controller, the power converter and the DC power supply may be provided together or separately in a flow battery system. As an example, a flow battery, a controller, a power converter and a DC power supply are four independent parts, and they can be detachably electrically connected with each other. As another example, a flow battery, a controller, and a power converter are integrally installed, and can be detachably electrically connected with a DC power supply. As another example, a power converter is integrally installed with a flow battery, and a controller and a DC power supply are installed integrally as an independent part that can be the detachably electrically connected with the flow battery and the power converter. As another example, a flow battery, a controller, a power converter and a DC power supply are integrally installed. As another example, a controller, a power converter and a DC power supply are integrally installed, being able to be detachably electrically connected to a flow battery.

It is envisaged that the charging initiation methods and flow battery systems described above may find applications in any circumstances where at least a flow battery system is used, such as household photovoltaic/battery/utility systems, net-zero building systems, on-board ship microgrid systems including renewal energy and energy storage, remote or island based microgrid systems for distributed generator optimization, and emergency power systems including uninterruptable power systems.

The term ‘comprise’, ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the invention within its scope. The use of expressions like “preferably” is not intended to limit the invention. Additions, deletions, and modifications within the purview of the skilled person may generally be made without departing from the spirit and scope of the invention, as is determined by the claims.

1. A charging initiation method for a flow battery for allowing charging of the flow battery from an AC power supply with a power converter having a minimum operational DC voltage, the flow battery comprising a positive electrolyte tank containing a positive electrolyte, a negative electrolyte tank containing a negative electrolyte, a cell stack comprising a positive porous electrode and a negative porous electrode, a positive electrolyte pump which when activated pumps the positive electrolyte from the positive electrolyte tank through the positive porous electrode, and a negative electrolyte pump which when activated pumps the negative electrolyte from the negative electrolyte tank through the negative porous electrode,
the charging initiation method comprising:
connecting a DC power supply to the positive porous electrode and the negative porous electrode to charge the cell stack, while the positive electrolyte pump and the negative electrolyte pump are deactivated; and
in response to a pre-charging condition:
disconnecting the DC power supply from the positive porous electrode and the negative porous electrode;
connecting the power converter coupled to the AC power supply to the positive porous electrode and the negative porous electrode to charge the cell stack from the AC power supply; and
activating the positive electrolyte pump and the negative electrolyte pump.

2. The charging initiation method of claim 1, further comprising, prior to connecting the DC power supply to the positive porous electrode and the negative porous electrode,
activating the positive electrolyte pump and the negative electrolyte pump to refresh positive electrolyte located in the positive porous electrode and negative electrolyte located in the negative porous electrode; and
deactivating the positive electrolyte pump and the negative electrolyte pump.

3. The charging initiation method of claim 1, wherein the DC power supply comprises an AC-DC power supply unit or a bidirectional/uni-directional DC-DC converter, the flow battery is a redox flow battery the positive electrolyte and the negative electrolyte comprise vanadium and the AC power supply is an AC power grid.

4. (canceled)

5. (canceled)

6. (canceled)

7. (canceled)

8. The charging initiation method of claim 1, wherein the pre-charging condition comprises a voltage between the positive porous electrode and the negative porous electrode exceeding a voltage threshold which is greater than or equal to the minimum operational DC voltage of the power converter.

9. The charging initiation method of claim 8, wherein the voltage threshold is greater than the minimum operational DC voltage by 1 volt, preferably 5 volts and more preferably 10 volts.

10. The charging initiation method of claim 9, wherein the voltage threshold is in the range 20 volts to 1500 volts.

11. The charging initiation method of claim 1, wherein the pre-charging condition comprises a charging current from the DC power supply falling below a current threshold in the range 1 A to 1000 A.

12. (canceled)

13. A controller for a flow battery system configured to control the flow battery system to carry out the charging initiation method of claim 1.

14. A flow battery system, comprising:
a flow battery comprising:
a positive electrolyte tank containing a positive electrolyte;
a negative electrolyte tank containing a negative electrolyte;
a cell stack comprising a positive porous electrode and a negative porous electrode;
a positive electrolyte pump, which when activated pumps the positive electrolyte from the negative electrolyte tank through the positive porous electrode; and
a negative electrolyte pump, which when activated pumps the negative electrolyte from the negative electrolyte tank through the negative porous electrode;
a DC power supply electrically couplable to the cell stack;
a power converter having a minimum operational DC voltage and being electrically couplable to the cell stack; and
a controller configured to execute a charging initiation method comprising:
connecting the DC power supply to the positive porous electrode and the negative porous electrode to charge the cell stack, while the positive electrolyte pump and the negative electrolyte pump are deactivated; and
in response to a pre-charging condition:
disconnecting the DC power supply from the positive porous electrode and the negative porous electrode;
connecting the power converter coupled to an AC power supply to the positive porous electrode and the negative porous electrode to charge the cell stack from the AC power supply; and
activating the positive electrolyte pump and the negative electrolyte pump.

15. The flow battery system of claim 14, wherein the charging initiation method further comprises, prior to connecting the DC power supply to the positive porous electrode and the negative porous electrode, activating the positive electrolyte pump and the negative electrolyte pump to refresh positive electrolyte located in the positive porous electrode and negative electrolyte located in the negative porous electrode and then deactivating the positive electrolyte pump and the negative electrolyte pump.

16. The flow battery system of claim 14, wherein the DC power supply comprises an AC-DC power supply unit or a bidirectional/uni-directional DC-DC converter, the flow battery is a redox flow battery and the positive electrolyte and the negative electrolyte comprise vanadium and wherein the AC power supply is an AC power grid.

17. (canceled)

18. (canceled)

19. (canceled)

20. (canceled)

21. The flow battery system of claim 14, wherein the pre-charging condition comprises a voltage between the positive porous electrode and the negative porous electrode exceeding a voltage threshold which is greater than or equal to the minimum operational DC voltage of the power converter.

22. The flow battery system of claim 21, wherein the voltage threshold is greater than the minimum operational DC voltage by 1 volt, preferably 5 volts and more preferably 10 volts.

23. The flow battery system of claim 21, wherein the voltage threshold is in the range 20 volts to 1500 volts.

24. The flow battery system of claim 14, wherein the pre-charging condition comprises a charging current from the DC power supply falling below a current threshold, in the range 1 A to 1000 A.

25. (canceled)
